(19) United States
(12) Patent Application Publication
(10) Pub. No.: US 2014/0219158 A1
(43) Pub. Date: Aug. 7, 2014

(54) WIRELESS COMMUNICATION SYSTEM, WIRELESS BASE STATION, WIRELESS TERMINAL AND WIRELESS COMMUNICATION METHOD

(71) Applicant: Shozo Fujino, Kanagawa (JP)

(72) Inventor: Shozo Fujino, Kanagawa (JP)

(73) Assignee: NEC CASIO MOBILE COMMUNICATIONS, LTD., Kanagawa (JP)

(21) Appl. No.: 14/240,986

(22) PCT Filed: Jul. 17, 2012
(86) PCT No.: PCT/JP2012/068076

§ 371 Date: Feb. 25, 2014

(30) Foreign Application Priority Data
Sep. 2, 2011 (JP) 2011-191740

(51) Int. Cl. H04L 29/06; H04L 12/861

(52) U.S. Cl. CPC H04L 65/4076; H04L 49/9005
USPC 370/312

(57) ABSTRACT

A wireless base station includes a unicast buffer for each individual wireless terminal and a Bcast/Mcast buffer for all wireless terminals. A wireless terminal includes means for transmitting a buffer change request for requesting the wireless base station to henceforth copy data queued into the Bcast/Mcast buffer to the unicast buffer, to the wireless base station. The wireless base station includes means for notifying the wireless terminal that data is buffered in the unicast buffer of the Bcast/Mcast buffer and means for queuing newly data that has been received, after receipt of the buffer change request from the wireless terminal, into the Bcast/Mcast buffer and also simultaneously copying the data to the unicast buffer.

### TECHNICAL FIELD

The present invention relates to a technique for a wireless terminal to receive broadcast or multicast data transmitted from a wireless base station without the loss of any data and without changing wake timing during a power-saving operation.

### BACKGROUND ART

As one of wireless communication techniques, WLAN (Wireless Local Area Network), the specifications of which were formulated by the IEEE (Institute of Electrical and Electronics Engineers) and the Wi-Fi (Wireless Fidelity) Alliance, and which are widely put into practical use currently, exists.

In order to reduce power consumption low, a WLAN terminal transitions from the sleep state to the wake state at a timing of receiving a beacon which is periodically transmitted from a WLAN AP (Access Point). If information indicating that unicast data is buffered at the WLAN AP is included in the beacon, the WLAN terminal performs an operation to obtain the data immediately after that. As the cycle of the wake timing is longer, sleep time is longer, and, therefore, power consumption is reduced. The obtaining operation is performed with the use of a PS (Power Save) poll or a null frame.

On the other hand, if broadcast (hereinafter abbreviated as Bcast) or multicast (hereinafter abbreviated as Mcast) data is buffered at the WLAN AP, the WLAN AP notifies the WLAN terminal that the data is buffered, by using the beacon that is to be tranmitted to the WLAN terminal, similarly to the case of the unicast data. As for the timing of the notification, a specially set cycle referred to as a DTIM (Delivery Traffic Indication Message) period is used. The obtaining operation of the WLAN terminal is not performed immediately after this notification, and Bcast or Mcast data is immediately transmitted from the WLAN AP.

As described above, the WLAN AP is provided with two kinds of buffers: a unicast buffer for buffering data that is to be transmitted to each individual WLAN terminal which has established a wireless link with the WLAN AP, and a Bcast/Mcast buffer for buffering data that is to be tranmitted to all WLAN terminals which have established wireless links with the WLAN AP.

The Wi-Fi Alliance formulated specifications of a standard referred to as Wi-Fi P2P (point-to-point) or Wi-Fi Direct as a technique enabling P2P communication between a WLAN terminal and a WLAN AP. The terminal function of a Wi-Fi P2P device is called a Wi-Fi P2P client, and a base station function of a Wi-Fi P2P device is called a Wi-Fi P2P group owner.

Patent Literature 1 describes the handling of received data in a wireless base station in consideration of reception of Bcast/Mcast data. In Patent Literature 1, however, even the protocol of received data is confirmed at the wireless base station, and, furthermore, the buffering policy is changed by referring to a table of registered data processing methods. Thus, the processing load for identifying the protocol is heavy. In addition, it is not possible to handle encrypted data.

Patent Literature 2 describes the handling of received data in a wireless base station in consideration of reception of Bcast/Mcast data. In Patent Literature 2, however, even the protocol of received data is confirmed at the wireless base station, and, furthermore, the content of proxy processing is changed by referring to a table of registered data processing methods. Thus, the processing load for identifying the protocol is heavy. In addition, it is not possible to handle encrypted data.

Patent Literature 3 and Patent Literature 4 describe the handling of received data in a wireless base station in consideration of reception of Bcast/Mcast data. In Patent Literature 3 and Patent Literature 4, the wake cycle is dynamically changed at the wireless terminal

Patent Literature 5 describes the handling of received data in a wireless base station in consideration of reception of Mcast data. In Patent Literature 5, a procedure for changing a DTIM is referred to. Even whether a Mcast service is participated in or not is confirmed at the wireless base station to change the DTIM.

### LITERATURE OF THE PRIOR ART

### Patent Literatures

Patent Literature 1: JP2006-067244A

Patent Literature 2: JP2008-092129A

Patent Literature 3: JP 2004 -128949A

Patent Literature 4: JP2007-288639A

Patent Literature 5: JP2007-288728A

### SUMMARY OF THE INVENTION

### Problem to be Solved by the Invention

As described above, in order for a wireless terminal to receive Bcast/Mcast data, the wireless terminal is required to receive the Bcast/Mcast data from a wireless base station immediately after being notified by the wireless base station that the Bcast/Mcast data is buffered and is required to wake in a specially determined cycle for receiving Bcast/Mcast data. Therefore, there are problems as shown below:

(1) In the case where this cycle is short, power consumption becomes high.
(2) In the case where this cycle is dynamically changed on the wireless terminal as in Patent Literature 3 and Patent Literature 4, the processing load on the wireless terminal becomes heavy.
(3) When this cycle is ignored for the purpose of reducing power consumption, it becomes impossible to receive Bcast/Mcast data.
(4) In the case where the protocol is identified and the buffering policy or the content of proxy processing is changed on the wireless base station as in Patent Literature 1 and Patent Literature 2, the processing load on the wireless base station becomes heavy, and it becomes impossible to handle encrypted data.

Therefore, the object of the present invention is to provide a wireless communication system, a wireless base station, a wireless terminal and a wireless communication method capable of solving the problems described above.

### Means for Solving the Problem

A wireless communication system of the present invention is

a wireless communication system including wireless terminal and a wireless base station, wherein

the wireless base station includes:

a unicast buffer that buffers data that is to be tranmitted to each individual wireless terminal that has established a wireless link with the wireless base station; and

a broadcast/multicast buffer that buffers data that is to be tranmitted to all wireless terminals that have established wireless links with the wireless base station; and

the wireless terminal includes:

a buffer change requesting section that transmits a buffer change request for requesting the wireless base station to henceforth copy data queued into the broadcast/multicast buffer to the unicast buffer, to the wireless base station; and

the wireless base station further includes:

a judgment section that judges whether received data is broadcast data, multicast data or unicast data;

a buffering notifying section that notifies the wireless terminal that data is buffered in the unicast buffer and also notifies the wireless terminal that data is buffered in the broadcast/multicast buffer; and

a queuing/copying section that, if after the buffer change request is received from the wireless terminal, newly broadcast data or multicast data is received, queues the received broadcast data or multicast data into the broadcast/multicast buffer and also simultaneously copies the broadcast data or multicast data to the unicast buffer.

A wireless base station of the present invention includes:

a unicast buffer that buffers data that is to be tranmitted to each individual wireless terminal that has established a wireless link with the wireless base station;

a broadcast/multicast buffer that buffers data that is to be tranmitted to all wireless terminals that have established wireless links with the wireless base station;

a judgment section that judges whether received data is broadcast data, multicast data or unicast data;

a buffering notifying section that notifies the wireless terminal that data is buffered in the unicast buffer and also notifies the wireless terminal that data is buffered in the broadcast/multicast buffer; and

a queuing/copying section that, if after a predetermined buffer change request is received from the wireless terminal, newly broadcast data or multicast data is received, queues the received broadcast data or multicast data into the broadcast/multicast buffer and also simultaneously copies the broadcast data or multicast data to the unicast buffer.

A wireless terminal of the present invention includes a buffer change requesting section that transmits a buffer change request for requesting a wireless base station to henceforth copy data queued into a broadcast/multicast buffer of the wireless base station to a unicast buffer of the wireless base station, to the wireless base station.

A first wireless communication method of the present invention is a wireless communication method by a wireless base station, the wireless base station including a unicast buffer that buffers data that is to be tranmitted to each individual wireless terminal that has established a wireless link with the wireless base station and a broadcast/multicast buffer that buffers data that is to be tranmitted to all wireless terminals that have established wireless links with the wireless base station, the method including the steps of:

if after a predetermined buffer change request is received from the wireless terminal, newly broadcast data or multicast data is received, queuing the received broadcast data or multicast data into the broadcast/multicast buffer and also simultaneously copying the broadcast data or multicast data to the unicast buffer; and

notifying the wireless terminal that data is buffered in the unicast buffer and also notifying the wireless terminal that data is buffered in the broadcast/multicast buffer.

A second wireless communication method of the present invention is a wireless communication method by a wireless terminal, the method including a request step of transmitting a buffer change request for requesting a wireless base station to henceforth copy data queued into a broadcast/multicast buffer of the wireless base station to a unicast buffer of the wireless base station, to the wireless base station.

### Effect of the Invention

According to the present invention, if after a buffer change request is received from a wireless terminal, newly broadcast data or multicast data is received, a wireless base station queues the received broadcast data or multicast data into a broadcast/multicast buffer and also simultaneously copies the data to a unicast buffer.

Therefore, when the wireless terminal wakes at the next wake timing, the wireless terminal can obtain the broadcast data or multicast data from the unicast buffer of the wireless base station.

Therefore, the wireless terminal can receive broadcast data or multicast data transmitted from the wireless base station without the loss of any data and without changing the wake timing.

Furthermore, by setting the cycle of the wake timing long in advance, the wireless terminal can reduce power consumption.

Furthermore, since it is not necessary for the wireless terminal to dynamically change the cycle of the wake timing, unlike Patent Literature 3 and Patent Literature 4, the processing load on the wireless terminal will not increase.

Furthermore, since it is not necessary for the wireless base station to identify the protocol to change the buffering policy or the content of proxy processing, unlike Patent Literature 1 and Patent Literature 2, the processing load on the wireless base station will not increase. Furthermore, it is possible to handle encrypted data.

### BRIEF DESCRIPTION OF THE DRAWINGS

FIG. 1 is a block diagram showing a configuration of a wireless system of an exemplary embodiment.

FIG. 2 is a sequence diagram showing an operation of the wireless system shown in FIG. 1.

FIG. 3 is a block diagram showing a configuration of a wireless system of an Example.

FIG. 4 is a sequence diagram showing an operation of the wireless system shown in FIG. 3.

### MODE FOR CARRYING OUT THE INVENTION

An exemplary embodiment for realizing the present invention will be described below with reference to drawings.

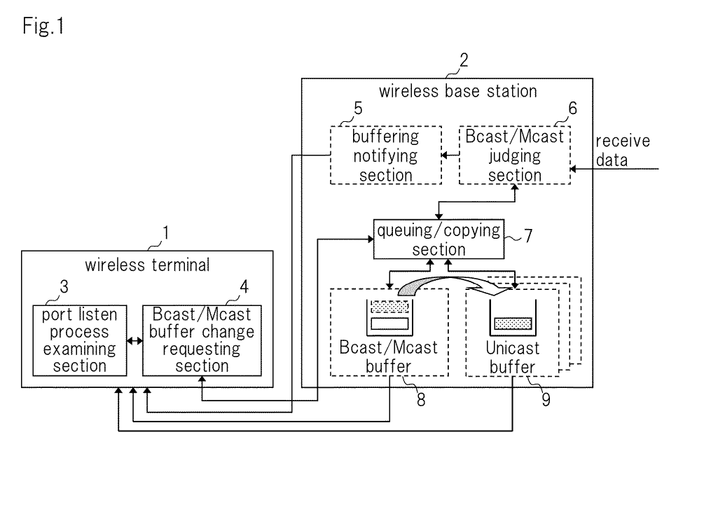

FIG. 1 shows a configuration of a wireless communication system of an exemplary embodiment.

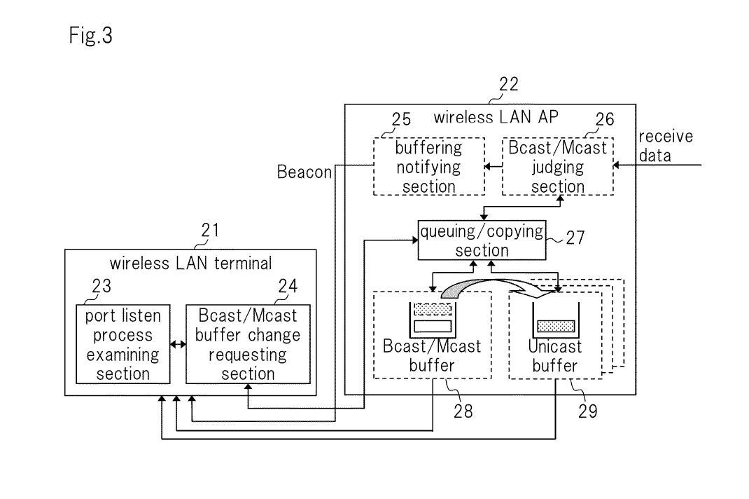

In FIG. 1, existing functions are indicated by dotted lines, and functions specific to the present invention are indicated by solid lines. Though the functions indicated by dotted lines are existing functions, they are necessary to realize the present invention (the same goes for FIG. 3 below).

As shown in FIG. 1, the wireless communication system of the present exemplary embodiment includes wireless terminal 1 and wireless base station 2. Though wireless base station 2 has established wireless links with one or more wireless terminals 1 using a particular wireless communication technique, only one wireless terminal 1 is shown in FIG. 1 for convenience of description.

Wireless terminal 1 has port listen process examining section 3 and Bcast/Mcast buffer change requesting section 4.

Wireless base station 2 has buffering notifying section 5, Bcast/Mcast judging section 6, queuing/copying section 7, Bcast/Mcast buffer 8 and unicast buffer 9.

Bcast/Mcast buffer 8 is intended to buffer data that is to be tranmitted to all wireless terminals 1 which have established wireless links with wireless base station 2, and one Bcast/Mcast buffer 8 is provided.

On the other hand, unicast buffer 9 is intended to buffer data that is to be tranmitted to each individual wireless terminal 1 which has established a wireless link with wireless base station 2. One or more unicast buffers 9 corresponding to the one or more wireless terminals 1 which have established wireless links with wireless base station 2, respectively, are provided.

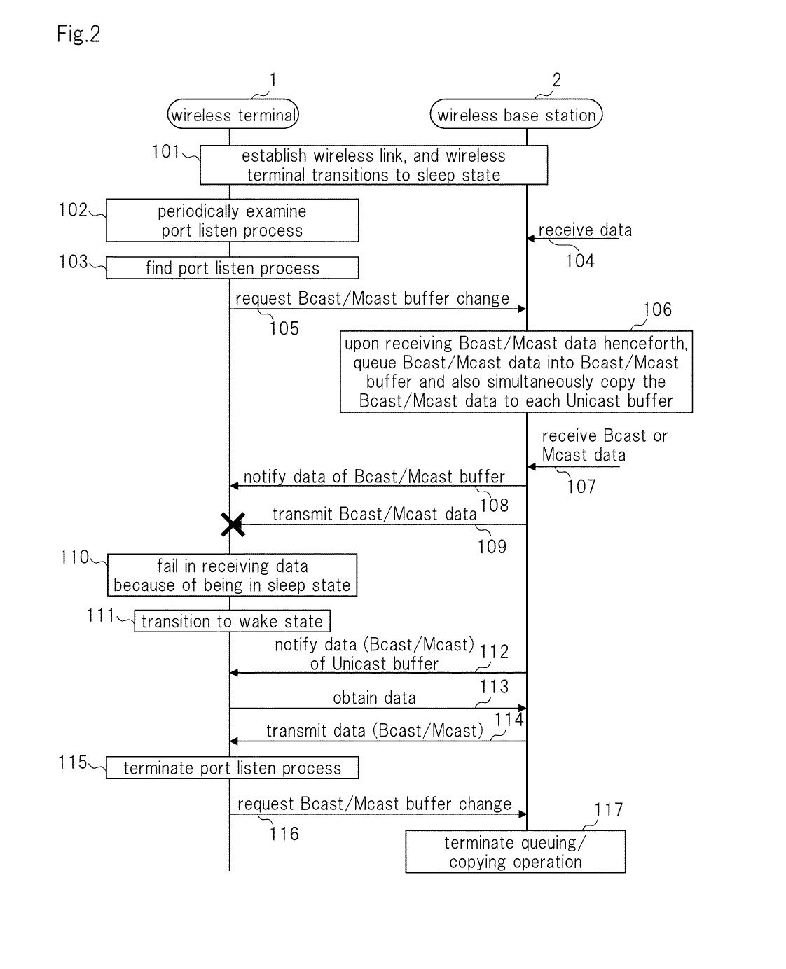

An operation of the wireless communication system shown in FIG. 1 will be described with reference to FIG. 2.

A wireless link has been established between wireless terminal 1 and wireless base station 2. Wireless terminal 1 has entered a power-saving operation and is in the sleep state (step 101).

At that time, wireless terminal 1 is performing an operation of transitioning from the sleep state to the wake state at the wake timing of predetermined cycle in order to receive information which is periodically transmitted from wireless base station 2.

Wireless base station 2 is performing a buffering operation of, upon receiving data that is to be tranmitted to wireless terminal 1 which is in the power-saving operation from inside or outside the wireless link (step 104), buffering the data into Bcast/Mcast buffer 8 if the data is Bcast/Mcast data and buffering the data into unicast buffer 9 if the data is unicast data.

Being triggered by the establishment of a wireless link with wireless base station 2, port listen process examining section 3 of wireless terminal 1 starts periodical examination about whether a port listen process is being executed in which wireless terminal 1 is performing a port listen operation in a “standby” state (step 102). When it is detected that data from wireless base station 2 is received at a port during the port listen process, this triggers start of communication with wireless base station 2.

If it is detected that the port listen process is being executed (step 103), Bcast/Mcast buffer change requesting section 4 of wireless terminal 1 transmits a Bcast/Mcast buffer change requesting control frame for requesting wireless base station 2 to henceforth copy data queued into Bcast/Mcast buffer 8 to unicast buffer 9 corresponding to wireless terminal 1, to wireless base station 2 (step 105).

Upon receiving the Bcast/Mcast buffer change request, wireless base station 2 henceforth terminates the above-mentioned buffering operation and starts a queuing/copying operation by queuing/copying section 7. That is, queuing/copying section 7 starts a queuing/copying operation of, upon receiving newly Bcast/Mcast data thereafter, queuing the Bcast/Mcast data into Bcast/Mcast buffer 8 and also simultaneously copying the Bcast/Mcast data to corresponding unicast buffer 9 (unicast buffer 9 corresponding to wireless terminal 1 which has transmitted the Bcast/Mcast buffer change request (step 106).

When wireless base station 2 receives Bcast/Mcast data (step 107), Bcast/Mcast judging section 6 judges whether the received data is Bcast/Mcast data or unicast data. If the data is Bcast/Mcast data, queuing/copying section 7 queues the Bcast/Mcast data into Bcast/Mcast buffer 8 and also simultaneously copies the Bcast/Mcast data to corresponding unicast buffer 9. Buffering notifying section 5 notifies wireless terminal 1 that the Bcast/Mcast data is buffered in Bcast/Mcast buffer 8 (step 108), and the Bcast/Mcast data is immediately transmitted from Bcast/Mcast buffer 8 (step 109). Because wireless terminal 1 is in the sleep state at that time, wireless terminal 1 fails in receiving the Bcast/Mcast data (step 110).

When wireless terminal 1 transitions from the sleep state to the wake state at the next wake timing (step 111), wireless terminal 1 can receive the notification from buffering notifying section 5 that data (the data is Bcast/Mcast data) is buffered in unicast buffer 9 corresponding to wireless terminal 1 (step 112).

Therefore, wireless terminal 1 obtains the data from unicast buffer 9 corresponding to wireless terminal 1 (step 113). As a result, the Bcast/Mcast data is transmitted from unicast buffer 9 to wireless terminal 1 (step 114).

When port listen process examining section 3 detects that the port listen process has ended (step 115), Bcast/Mcast buffer change requesting section 4 of wireless terminal 1 transmits a Bcast/Mcast buffer change requesting control frame for requesting wireless base station 2 to terminate the queuing/copying operation by queuing/copying section 7 and to return the original buffering operation to wireless base station 2 (step 116).

When wireless base station 2 receives the Bcast/Mcast buffer change request, queuing/copying section 7 terminates the queuing/copying operation (step 117).

By doing this, it becomes possible for wireless terminal 1 to receive Bcast/Mcast data transmitted from wireless base station 2 without the loss of any data and without changing the wake timing during power-saving operation.

Furthermore, by setting the cycle of the wake timing long in advance, wireless terminal 1 can reduce power consumption.

Furthermore, since it is not necessary for wireless terminal 1 to dynamically change the cycle of the wake timing, unlike Patent Literature 3 and Patent Literature 4, the processing load on wireless terminal 1 will not increase.

Furthermore, since it is not necessary for wireless base station 2 to identify the protocol in order to change the buffering policy or the content of proxy processing, unlike Patent Literature 1 and Patent Literature 2, the processing load on wireless base station 2 will not increase. Furthermore, it is possible to handle encrypted data.

### EXAMPLE

An example in which the exemplary embodiment is specifically embodied will be described below.

As shown in FIG. 3, a wireless communication system of the present example uses WLAN as a wireless communication technique. Wireless LAN terminal 21 is applied as wireless terminal 1 in FIG. 1, and wireless LAN AP 22 is applied as wireless base station 2 in FIG. 1.

Wireless LAN terminal 21 has port listen process examining section 23 and Bcast/Mcast buffer change requesting section 24. These components correspond to port listen process examining section 3 and Bcast/Mcast buffer change requesting section 4 in FIG. 1, respectively.

Wireless LAN AP 22 has buffering notifying section 25, Bcast/Mcast judging section 26, queuing/copying section 27, Bcast/Mcast buffer 28 and a unicast buffer 29. These components correspond to buffering notifying section 5, Bcast/Mcast judging section 6, queuing/copying section 7, Bcast/Mcast buffer 8 and unicast buffer 9 in FIG. 1, respectively.

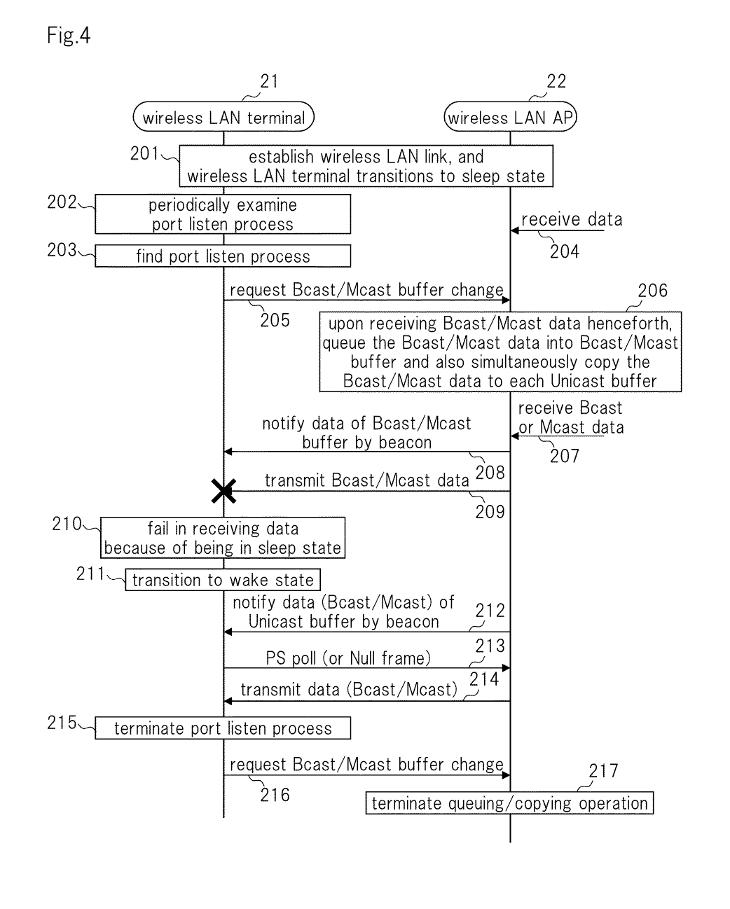

An operation of the wireless communication system shown in FIG. 3 will be described with reference to FIG. 4.

A wireless LAN link has been established between wireless LAN terminal 21 and wireless LAN AP 22. Wireless LAN terminal 21 has entered a power-saving operation and is in the sleep state (step 201).

At this time, wireless LAN terminal 21 is performing an operation of transitioning from the sleep state to the wake state at the wake timing of predetermined cycle in order to receive a beacon which is periodically transmitted from wireless LAN AP 22.

Wireless LAN AP 22 is performing a buffering operation of, upon receiving data that is to be tranmitted to wireless LAN terminal 21 which is in the power-saving operation from inside or outside the wireless LAN link (step 204), buffering the data into Bcast/Mcast buffer 28 if the data is Bcast/Mcast data and buffering the data into unicast buffer 29 if the data is unicast data.

Being triggered by the establishment of a wireless link with wireless LAN AP 22, port listen process examining section 23 of wireless LAN terminal 21 starts periodical examination about whether a port listen process is being executed in which wireless LAN terminal 21 is performing a port listen operation in a “standby” state (step 202). When it is detected that data from wireless LAN AP 22 is received at a port during the port listen process, this triggers start of communication with wireless LAN AP 22.

If it is detected that the port listen process is being executed (step 203), Bcast/Mcast buffer change requesting section 24 of wireless LAN terminal 21 transmits a Bcast/Mcast buffer change requesting control frame for requesting wireless LAN AP 22 to henceforth copy data queued into Bcast/Mcast buffer 8 to unicast buffer 29 corresponding to wireless LAN terminal 21, to wireless LAN AP 22 (step 205).

Upon receiving the Bcast/Mcast buffer change request, wireless LAN AP 22 henceforth terminates the above-mentioned buffering operation and starts a queuing/copying operation by queuing/copying section 27. That is, queuing/copying section 27 starts a queuing/copying operation of, upon receiving newly Bcast/Mcast data thereafter, queuing the Bcast/Mcast data into Bcast/Mcast buffer 28 and also simultaneously copying the Bcast/Mcast data to corresponding unicast buffer 29 (unicast buffer 29 corresponding to wireless LAN terminal 21 which has transmitted the Bcast/Mcast buffer change request (step 206).

When wireless LAN AP 22 receives Bcast/Mcast data (step 207), Bcast/Mcast judging section 26 judges whether the received data is Bcast/Mcast data or unicast data. If the data is Bcast/Mcast data, queuing/copying section 27 queues the Bcast/Mcast data into Bcast/Mcast buffer 28 and also simultaneously copies the Bcast/Mcast data to a corresponding unicast buffer 29. Buffering notifying section 25 notifies wireless LAN terminal 21, by a beacon, that the Bcast/Mcast data is buffered in Bcast/Mcast buffer 28 (step 208), and the Bcast/Mcast data is immediately transmitted from Bcast/Mcast buffer 28 (step 209). Because wireless LAN terminal 21 is in the sleep state at this time, wireless LAN terminal 21 fails in receiving the Bcast/Mcast data (step 210).

When wireless LAN terminal 21 transitions from the sleep state to the wake state at the next wake timing (step 211), wireless LAN terminal 21 can receive, by a beacon, the notification from buffering notifying section 25 that data (the data is Bcast/Mcast data) is buffered in unicast buffer 29 corresponding to wireless LAN terminal 21 (step 212).

Therefore, wireless LAN terminal 21 obtains the data from unicast buffer 29 corresponding to wireless LAN terminal 21 by a PS poll or a null frame (step 213). As a result, the Bcast/Mcast data is transmitted from unicast buffer 29 to wireless LAN terminal 21 (step 214).

When port listen process examining section 23 detects that the port listen process has ended (step 215), Bcast/Mcast buffer change requesting section 24 of wireless LAN terminal 21 transmits a Bcast/Mcast buffer change requesting control frame for requesting wireless LAN AP 22 to terminate the queuing/copying operation by queuing/copying section 27 and return the original buffering operation to wireless LAN AP 22 (step 216).

When wireless LAN AP 22 receives the Bcast/Mcast buffer change request, queuing/copying section 27 terminates the queuing/copying operation (step 217).

By doing this, it becomes possible for wireless LAN terminal 21 to receive Bcast/Mcast data transmitted from wireless LAN AP 22 without the loss of any data and without changing the wake timing during the power-saving operation.

Furthermore, by setting the cycle of the wake timing long in advance, wireless LAN terminal 21 can reduce power consumption.

Furthermore, since it is not necessary for wireless LAN terminal 21 to dynamically change the cycle of the wake timing, unlike Patent Literature 3 and Patent Literature 4, the processing load on wireless LAN terminal 21 will not increase.

Furthermore, since it is not necessary for wireless LAN AP 22 to identify the protocol and change the buffering policy or the content of proxy processing, unlike Patent Literature 1 and Patent Literature 2, the processing load on wireless LAN AP 22 will not increase. Furthermore, it is possible to handle encrypted data.

The present invention has been described above with reference to the exemplary embodiment and the example. The present invention, however, is not limited to the above exemplary embodiment and the above example. Various modifications which can be understood by one skilled in the art can be made in the configuration and details of the present invention within the scope of the present invention.

For example, the Bcast/Mcast buffer change requesting control frame can be based not only on an ordinary Wi-Fi specification format but also on a Wi-Fi P2P (Wi-Fi Direct) format.

Furthermore, in the case where wireless links are established in accordance with the Wi-Fi P2P (Wi-Fi Direct) specifications to construct a group to use a particular application, it is possible to, by a wireless base station causing the interval of transmitting Bcast/Mcast data to be the same as the largest value among the values of individual wake cycles set for wireless terminals which have established the wireless links, prevent any of the wireless terminals which have established the wireless links from losing Bcast/Mcast data during its standby operation.

This application claims priority based on Japanese Patent Application No. 2011-191740 filed on Sep. 2, 2011, the disclosure of which is hereby incorporated by reference thereto in its entirety.

1. A wireless communication system comprising a wireless terminal and a wireless base station, wherein
said wireless base station comprises:
a unicast buffer that buffers data that is to be tranmitted to each individual wireless terminal that has established a wireless link with said wireless base station; and
a broadcast/multicast buffer that buffers data that is to be tranmitted to all wireless terminals that have established wireless links with said wireless base station; and
said wireless terminal comprises:
a buffer change requesting section that transmits a buffer change request for requesting said wireless base station to henceforth copy data queued into said broadcast/multicast buffer to said unicast buffer, to said wireless base station; and
said wireless base station further comprises:
a judgment section that judges whether received data is broadcast data, multicast data or unicast data;
a buffering notifying section that notifies said wireless terminal that data is buffered in said unicast buffer and also notifies said wireless terminal that data is buffered in said broadcast/multicast buffer; and
a queuing/copying section that, if after the buffer change request is received from said wireless terminal, newly broadcast data or multicast data is received, queues the received broadcast data or multicast data into said broadcast/multicast buffer and also simultaneously copies the broadcast data or multicast data to said unicast buffer.

2. The wireless communication system according to claim 1, wherein said wireless terminal further comprises a process examining section that, when a wireless link is established with said wireless base station, is triggered to examine whether a process is being executed in which said terminal performs a port listen operation in a standby state; and
if the process is being executed, said buffer change requesting section transmits the buffer change request to said wireless base station.

3. A wireless base station comprising:
a unicast buffer that buffers data that is to be tranmitted to each individual wireless terminal that has established a wireless link with said wireless base station;
a broadcast/multicast buffer that buffers data that is to be tranmitted to all wireless terminals that have established wireless links with said wireless base station;
a judgment section that judges whether received data is broadcast data, multicast data or unicast data;
a buffering notifying section that notifies said wireless terminal that data is buffered in said unicast buffer and also notifies said wireless terminal that data is buffered in said broadcast/multicast buffer; and
a queuing/copying section that, if after a predetermined buffer change request is received from said wireless terminal, newly broadcast data or multicast data is received, queues the received broadcast data or multicast data into said broadcast/multicast buffer and also simultaneously copies the broadcast data or multicast data to said unicast buffer.

4. A wireless terminal comprising a buffer change requesting section that transmits a buffer change request for requesting a wireless base station to henceforth copy data queued into a broadcast/multicast buffer of the wireless base station to a unicast buffer of the wireless base station, to the wireless base station.

5. The wireless terminal according to claim 4, further comprising a process examining section that, when a wireless link is established with said wireless base station, is triggered to examine whether a process is being executed in which said terminal performs a port listen operation in a standby state; wherein
if the process is being executed, said buffer change requesting section transmits the buffer change request to said wireless base station.

6. A wireless communication method by a wireless base station, the wireless base station comprising a unicast buffer that buffers data that is to be tranmitted to each individual wireless terminal that has established a wireless link with the wireless base station and a broadcast/multicast buffer that buffers data that is to be tranmitted to all wireless terminals that have established wireless links with the wireless base station, the method comprising the steps of:
if after a predetermined buffer change request is received from the wireless terminal, newly broadcast data or multicast data is received, queuing the received broadcast data or multicast data into the broadcast/multicast buffer and also simultaneously copying the broadcast data or multicast data to the unicast buffer; and
notifying the wireless terminal that data is buffered in the unicast buffer and also notifying the wireless terminal that data is buffered in the broadcast/multicast buffer.

7. A wireless communication method by a wireless terminal, the method comprising a request step of transmitting a buffer change request for requesting a wireless base station to henceforth copy data queued into a broadcast/multicast buffer of the wireless base station to a unicast buffer of the wireless base station, to the wireless base station.

8. The wireless communication method according to claim 7, further comprising an examination step of, when a wireless link is established with the wireless base station, being triggered to examine whether a process is being executed in which the terminal performs a port listen operation in a standby state; wherein
at said request step, if the process is being executed, the buffer change request is transmitted to the wireless base station.
